(19) United States
(12) Patent Application Publication
(10) Pub. No.: US 2017/0232795 A1
(43) Pub. Date: Aug. 17, 2017

(54) TIRE WITH TREAD FOR LOW TEMPERATURE PERFORMANCE AND WET TRACTION

(71) Applicant: The Goodyear Tire & Rubber Company, Akron, OH (US)

(72) Inventors: Nihat Ali Isitman, Ettelbruck (LU); Pascal Patrick Steiner, Vichten (LU); Manuela Pompei, Reuler (LU); Philippe Schmit, Chantemelle (BE); Georges Marcel Victor Thielen, Schouweiler (LU)

(21) Appl. No.: 15/043,773

(22) Filed: Feb. 15, 2016

(51) Int. Cl. B60C 1/00; B60C 11/00; C08L 9/06

(52) U.S. Cl. CPC B60C 1/0016; C08L 9/06; B60C 11/0008; B60C 2011/0025

(57) ABSTRACT

This invention relates to a tire with a tread of a rubber composition that promotes a combination of winter traction at low temperatures and for promoting wet traction. The tread rubber composition contains a combination of low surface area silica and high softening point traction resin. Elastomers for the tread rubber composition are comprised of high cis 1,4-polybutadiene rubber and styrene/butadiene rubber.

### FIELD OF THE INVENTION

This invention relates to a tire with a tread of a rubber composition for promoting a combination of winter performance and wet traction. For such purpose, the tread rubber composition contains a combination of low surface area precipitated silica reinforcing filler and high softening point traction resin. Elastomers for the tread rubber composition are comprised of high cis 1,4-polybutadiene rubber and styrene/butadiene rubber.

### BACKGROUND OF THE INVENTION

Tires are sometimes desired with treads for promoting traction on wet surfaces. Various rubber compositions may be proposed for such tire treads.

For example, tire tread rubber compositions which contain high molecular weight, high Tg (high glass transition temperature) diene based synthetic elastomer(s) might be desired for such purpose particularly for wet traction (traction of tire treads on wet road surfaces). Such tire tread may be desired where its reinforcing filler is primarily precipitated silica with its reinforcing filler therefore considered as being precipitated silica rich.

In one embodiment, the predictive wet traction performance for the tread rubber composition is based on a maximization of its tan delta physical property at about −10° C.

For such purpose, it is desired to evaluate providing such tread rubber composition with a high Tg elastomer to promote wet traction for the tire tread where the rubber composition also has a lower stiffness physical property at lower temperatures to promote cold weather winter performance, particularly for vehicular snow driving.

In one embodiment, the predictive cold weather performance for the tread rubber composition is based on a minimization of its stiffness physical property at about −20° C. (e.g. minimized storage modulus G′ at about −20° C.).

Therefore, it desirable to evaluate providing such vehicular tire tread with a rubber composition containing a combination of elastomers with high and intermediate glass transition temperatures (Tg's) to promote an optimized (maximized) tan delta property at about −10° C. (for predictive wet traction performance) combined with an optimized (minimized) stiffness property of a storage modulus (G′) at about −20° C. (for predictive cold weather performance improvement).

It is considered that significant challenges are presented for providing such tire tread rubber compositions that provide a combination of both wet traction and winter performance.

To achieve the challenge of providing such balance of tread rubber performances with tread rubber compositions, it is recognized that concessions and adjustments would be expected.

To meet such challenge, it is also desired to evaluate a rubber composition containing a combination of precipitated silica filler reinforcement and traction promoting resin comprised of:

(A) a high content of silica reinforcement comprised of precipitated silicas of varying surface areas to evaluate their contribution for a traction promoting resin-containing tread, combined with

(B) traction promoting resins of varying softening points to evaluate their aid in promoting wet traction for the high silica reinforcement-containing tread.

In the description of this invention, the terms “compounded” rubber compositions and “compounds” are used to refer to rubber compositions which have been compounded, or blended, with appropriate rubber compounding ingredients. The terms “rubber” and “elastomer” may be used interchangeably unless otherwise indicated. The amounts of materials are usually expressed in parts of material per 100 parts of rubber by weight (phr).

The glass transition temperature (Tg) of the elastomers may be determined by DSC (differential scanning calorimetry) measurements at a temperature rising rate of about 10° C. per minute, as would be understood and well known by one having skill in such art. A softening point (Sp) of a resin may be determined by ASTM E28 which may sometimes be known as a ring and ball softening point determination.

### SUMMARY AND PRACTICE OF THE INVENTION

In accordance with this invention, a pneumatic tire is provided having a circumferential rubber tread intended to be ground-contacting, where said tread is a rubber composition comprised of, based on parts by weight per 100 parts by weight elastomer (phr):

(A) 100 phr of conjugated diene-based elastomers comprised of;
(1) about 50 to about 10 phr of cis 1,4-polybutadiene rubber having a Tg in a range of from about −90° C. to about −110° C. and an isomeric cis 1,4-content of at least 95 percent,
(2) about 50 to about 90 phr of styrene/butadiene elastomer having a Tg in a range of from about −65° C. to about −55° C.;

(B) about 100 to about 200, alternately from about 120 to about 180, phr of rubber reinforcing filler comprised of rubber reinforcing carbon black and precipitated silica (amorphous synthetic precipitated silica) having a nitrogen (BET) surface area of in a range of from about 50 to about 110, alternately from about 80 to about 100 m²/g, wherein the rubber reinforcing carbon black is present in an amount of from about 2 to about 15 phr, together with silica coupling agent for the precipitated silica having a moiety reactive with hydroxyl groups (e.g. silanol groups) on said precipitated silica and another different moiety interactive with said diene-based elastomers, and

(C) about 30 to about 70 phr of traction promoting resin (e.g. traction between said tread and ground) having a softening point (Sp) in a range of from about 110° C. to about 170° C. comprised of at least one of styrene-alphamethylstyrene copolymer resin having a softening point in a range of from about 110° C. to about 130° C., terpene-phenol resin having a softening point in a range of from about 120° C. to about 170° C., coumarone-indene resins having a softening point in a range of from about 110° C. to about 170° C., petroleum hydrocarbon resins having a softening point in a range of from about 110° C. to about 170° C., terpene polymer resins having a softening point in a range of from about 110° C. to about 170° C. and rosin derived resins and copolymers and copolymers having a softening point in a range of from about 110° C. to about 170° C.

In one embodiment said traction promoting resin is comprised of at least one of said styrene-alphamethylstyrene resin and terpene-phenol resin.

In one embodiment, said styrene/butadiene elastomer has a styrene content in a range of from about 10 to about 50 percent.

In one embodiment, said styrene/butadiene has a vinyl 1,2-content based on its polybutadiene portion in a range of from about 25 to about 35 percent.

In one embodiment, said styrene/butadiene elastomer is an end-functionalized styrene/butadiene elastomer with functional groups reactive with hydroxyl groups on said precipitated silica comprised of alkoxy and at least one of primary amine and thiol groups (e.g. alkoxy and thiol groups) having a Tg in a range of from about −65° C. to about −55° C.

In further accordance with this invention, said tire tread is provided as a sulfur cured rubber composition.

In one embodiment said tread rubber composition further contains up to 25, alternately up to about 15, phr of at least one additional diene based elastomer. Such additional elastomer may be comprised of, for example, at least one of cis 1,4-polyisoprene (natural rubber or synthetic), and copolymers of isoprene and butadiene.

In one embodiment, said precipitated silica and silica coupling agent may be pre-reacted to form a composite thereof prior to their addition to the rubber composition.

In one embodiment, said precipitated silica and silica coupling agent may be added to the rubber composition and reacted together in situ within the rubber composition.

The precipitated silica reinforcement, as indicated, may, for example, be characterized by having a BET surface area, as measured using nitrogen gas, in the range of about 50 to about 110, alternately from about 80 to about 100, square meters per gram. The BET method of measuring surface area might be described, for example, in the Journal of the American Chemical Society, (1938), Volume 60, as well as ASTM D3037.

Representative examples of rubber reinforcing carbon blacks are, for example, and not intended to be limiting, as referenced in The Vanderbilt Rubber Handbook, 13^{th} edition, year 1990, on Pages 417 and 418 with their ASTM designations. Such rubber reinforcing carbon blacks may have iodine absorptions ranging from, for example, 60 to 240 g/kg and DBP values ranging from 34 to 150 cc/100 g.

Representative of silica coupling agents for the precipitated silica are comprised of, for example;

(A) bis(3-trialkoxysilylalkyl) polysulfide containing an average in range of from about 2 to about 4, alternatively from about 2 to about 2.6 or from about 3.2 to about 3.8, sulfur atoms in its polysulfide connecting bridge, or

(B) an organoalkoxymercaptosilane, or

(C) their combination.

Representative of such bis(3-trialkoxysilylalkyl) polysulfide is comprised of bis(3-triethoxysilylpropyl) polysulfide.

In one embodiment, the styrene/alphamethylstyrene traction promoting resin is, for example, a relatively short chain copolymer of styrene and alphamethylstyrene. In one embodiment, such a resin may be suitably prepared, for example, by cationic copolymerization of styrene and alphamethylstyrene in a hydrocarbon solvent. The styrene/alphamethylstyrene resin may have, for example, a styrene content in a range of from about 10 to about 90 percent. The styrene/alphamethylstyrene resin may have a softening point, for. A example, in a range of from about 110° C. to 150° C., alternately from about 110° C. to about 130° C. Exemplary styrene/alphamethylstyrene resin may be, for example, Norsolene™ W120 from Cray Valley.

In one embodiment, the resin is a terpene-phenol resin. Such terpene-phenol resin may be, for example, a copolymer of phenolic monomer with a terpene such as, for example, limonene and pinene. The terpene-phenol resin may have a softening point, for example, in a range of from about 110° C. to about 170° C., alternately from about 140° C. to about 150° C. An exemplary terpene-phenol resin may be, for example YS Polyster T145 from Yasuhara Chemical Co.

In one embodiment the resin is a coumarone-indene resin. Such coumarone-indene resin may have a softening point, for example, in a range of from about 110° C. to about 170° C., alternately from about 110° C. to about 150° C., containing coumarone and indene as the monomer components making up the resin skeleton (main chain). Minor amounts of monomers other than coumarone and indene may be incorporated into the skeleton such as, for example, methyl coumarone, styrene, alphamethylstyrene, methylindene, vinyltoluene, dicyclopentadiene, cycopentadiene, and diolefins such as isoprene and piperlyene.

In one embodiment, the resin is a petroleum hydrocarbon resin having a softening point (Sp) in a range of, for example, in a range of from about 110° C. to about 170° C. Such petroleum hydrocarbon resin may be, for example, an aromatic and/or nonaromatic (e.g. paraffinic) based resin. Various petroleum resins are available. Some petroleum hydrocarbon resins have a low degree of unsaturation and high aromatic content, whereas some are highly unsaturated and yet some contain no aromatic structure at all. Differences in the resins are largely due to the olefins contained in the petroleum based feedstock from which the resins are derived. Conventional olefins for such resins include any C5 olefins (olefins and diolefines containing an average of five carbon atoms) such as, for example, cyclopentadiene, dicyclopentadiene, isoprene and piperylene, and any C9 olefins (olefins and diolefins containing an average of 9 carbon atoms) such as, for example, vinyltoluene and alphamethylstyrene. Such resins may be made from mixtures of such C5 and C9 olefins.

In one embodiment, said resin is a terpene resin. Such resin may be comprised of, for example, polymers of at least one of limonene, alpha pinene and beta pinene and having a softening point in a range of, for example, from about 110° C. to about 170° C., alternately from about 110° C. to about 160° C.

In one embodiment, the resin is a terpene-phenol resin having a softening point of, for example, in a range of from about 120° C. to about 170° C., alternately from about 120° C. to about 150° C. Such terpene-phenol resin may be, for example, a copolymer of phenolic monomer with a terpene such as, for example, limonene and pinene.

In one embodiment, the resin is a resin derived from rosin and derivatives having a softening point (Sp) of, for example, om a range of from about 110° C. to about 170° C. Representative thereof are, for example, gum rosin and wood rosin. Gum rosin and wood rosin have similar compositions, although the amount of components of the rosins may vary. Such resins may be in the form of esters of rosin acids and polyols such as pentaerythritol or glycol. In one embodiment, said resin may be at least partially hydrogenated (which may be fully hydrogenated).

It is readily understood by those having skill in the art that the vulcanizable rubber composition would be compounded by methods generally known in the rubber compounding art. In addition, said compositions could also contain fatty acid, zinc oxide, waxes, antioxidants, antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Usually it is desired that the sulfur-vulcanizing agent is elemental sulfur. The sulfur-vulcanizing agent may be used in an amount ranging, for example, from about 0.5 to 8 phr, with a range of from 1.2 to 6 phr being often more desirable. Typical amounts of processing aids for the rubber composition, where used, may comprise, for example, from about 1 to about 10 phr. Typical processing aids may be, for example, at least one of various fatty acids (e.g. at least one of palmitic, stearic and oleic acids) or fatty acid salts.

Rubber processing oils may be used, where desired, in an amount of, for example, from about 10 up to about 100, alternately from about 15 to about 45 phr, to aid in processing the uncured rubber composition. The processing oil used may include both extending oil present in the elastomers and process oil added during compounding. Suitable process oils include various petroleum based oils as are known in the art, including aromatic, paraffinic, naphthenic, and low PCA oils, such as MES, TDAE, and heavy naphthenic oils, and various triglyceride based vegetable oils such as sunflower, soybean, and safflower oils, particularly soybean oil.

Typical amounts of antioxidants may comprise, for example, about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants may comprise, for example, about 1 to 5 phr. Typical amounts of fatty acids, if used, which can include stearic acid comprised of about 0.5 to about 5 phr. Typical amounts of zinc oxide may comprise, for example, about 2 to about 5 phr. Typical amounts of waxes comprise about 1 to about 5 phr. Often microcrystalline waxes are used. Typical amounts of peptizers, when used, may be used in amounts of, for example, about 0.1 to about 1 phr. Typical peptizers may be, for example, pentachlorothiophenol and dibenzamidodiphenyl disulfide.

Sulfur vulcanization accelerators are used to control the time and/or temperature required for vulcanization and to improve the properties of the vulcanizate. In one embodiment, a single accelerator system may be used, i.e., primary accelerator. The primary accelerator(s) may be used in total amounts ranging, for example, from about 0.5 to about 4, sometimes desirably about 0.8 to about 2.5, phr. In another embodiment, combinations of a primary and a secondary accelerator might be used with the secondary accelerator being used in smaller amounts, such as, for example, from about 0.05 to about 4 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, sulfenamides, and xanthates. Often desirably the primary accelerator is a sulfenamide. If a second accelerator is used, the secondary accelerator is often desirably a guanidine such as for example a diphenylguanidine.

The mixing of the vulcanizable rubber composition can be accomplished by methods known to those having skill in the rubber mixing art. For example, the ingredients are typically mixed in at least two stages, namely at least one non-productive stage followed by a productive mix stage. The final curatives, including sulfur-vulcanizing agents, are typically mixed in the final stage, which is conventionally called the “productive” mix stage, in which the mixing typically occurs at a temperature, or ultimate temperature, lower than the mix temperature(s) of the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C., alternately in a range of between about 140° C. to about 170° C. The appropriate duration of the thermomechanical working varies as a function of the operating conditions and the volume and nature of the components. For example, the thermomechanical working may be in a range of from 1 to 20, alternately from about 4 to about 8, minutes.

The pneumatic tire of the present invention may be, for example, a passenger tire, truck tire, a race tire, aircraft tire, agricultural tire, earthmover tire and off-the-road tire. Usually desirably the tire is a passenger or truck tire. The tire may also be a radial or bias ply tire, with a radial ply tire being usually desired.

Vulcanization of the pneumatic tire containing the tire tread of the present invention is generally carried out at conventional temperatures in a range of, for example, from about 140° C. to 200° C. Often it is desired that the vulcanization is conducted at temperatures ranging from about 150° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The following example is presented for the purposes of illustrating and not limiting the present invention. The parts and percentages are parts by weight, usually parts by weight per 100 parts by weight rubber (phr) unless otherwise indicated.

### EXAMPLE I

In this example, exemplary rubber compositions for a tire tread were prepared for evaluation for use to promote a combination of wet traction and cold weather (winter) performance.

A control rubber composition was prepared identified as rubber Sample A and experimental rubber compositions identified as rubber Samples B through E were prepared as precipitated silica reinforced rubber compositions containing synthetic elastomers as a combination of styrene/butadiene rubber having an intermediate Tg of about −60° C. and a cis 1,4-polybutadiene rubber having a low Tg of about −106° C. together with traction resin and silica coupler for the precipitated silica.

The rubber compositions are illustrated in the following Table 1.

TABLE 1

| | Parts by Weight (phr) | | | | |
|---|---|---|---|---|---|
| Material | Cntrl A | Exp B | Exp C | Exp D | Exp. E |
| Non-Productive Mixing | | | | | |
| (NP) | | | | | |
| Cis 1,4-polybutdiene | 25 | 25 | 25 | 25 | 25 |
| rubber¹ | | | | | |
| Styrene/butadiene | 75 | 75 | 75 | 75 | 75 |
| rubber² | | | | | |
| Traction resin A³ | 36 | 36 | 36 | 0 | 0 |
| Traction resin B⁴ | 0 | 0 | 0 | 37 | 0 |
| Traction resin C⁵ | 0 | 0 | 0 | 0 | 47 |
| Rubber processing oil⁶ | 26 | 15 | 23 | 23 | 16 |
| Precipitated silica X⁷ | 140 | 0 | 0 | 0 | 0 |
| Precipitated silica Y⁸ | 0 | 140 | 160 | 160 | 160 |
| Silica coupler⁹ | 8.8 | 6.3 | 7.2 | 7.2 | 7.2 |
| Fatty acids¹⁰ | 5 | 5 | 5 | 5 | 5 |
| Carbon black (N330) | 1 | 1 | 1 | 1 | 1 |
| Wax (paraffinic and | 1.5 | 1.5 | 1.5 | 1.5 | 1.5 |
| microcrystalline) | | | | | |
| Antioxidant(s) | 5 | 5 | 5 | 5 | 5 |
| Zinc oxide | 2.5 | 2.5 | 2.5 | 2.5 | 2.5 |
| Productive Mixing (P) | | | | | |
| Sulfur | 1.2 | 1.5 | 1.5 | 1.5 | 1.2 |
| Sulfur cure accelerators¹¹ | 5.5 | 3.8 | 4.4 | 4.7 | 5.1 |

¹High cis 1,4-polybutadiene rubber as Budene1229 ™ from The Goodyear Tire & Rubber Company having a Tg of about −106° C. having a vinyl 1,2-content of less than about 4 percent and a cis 1,4-content of more than about 96 percent
²Styrene/butadiene rubber (SSBR) prepared by organic solution prepared polymerization of styrene and 1,3-butadiene monomers having a styrene content of about 15 percent and a vinyl 1,2-content of about 30 percent (based on the polybutadiene portion of the SSBR) with a Tg of about −60° C. obtained as Sprintan SLR 3402 ™ from Trinseo. The SSBR was a functionalized SSBR end functionalized with functional groups understood to be comprised of alkoxy and thiol groups.
³Traction resin A as copolymer of styrene and alphamethylstyrene (styrene-alphamethylstyrene copolymer) having a softening point of about 80° C. to about 90° C. obtained as Sylvares SA85 ™ from Arizona Chemicals
⁴Traction resin B as copolymer of styrene and alphamethylstyrene (styrene-alphamethylstyrene copolymer) having a softening point of about 110° C. to 130° C. obtained as Norsolene W120 ™ from Total Petrochemicals
⁵Traction resin C as copolymer of terpene and phenol having a softening point of about 140° C. to 150° C. obtained as YS Polyster T145 ™ from Yasuhara Chemical
⁶Rubber processing oil as a TDAE type petroleum based oil
⁷Precipitated silica X as HiSil315G-D ™ from PPG having a BET (nitrogen) surface area of about 125 m²/g
⁸Precipitated silica Y as EZ090G-D ™ from PPG having a BET (nitrogen) surface area of about 90 m²/g
⁹Silica coupler comprised of a bis(3-triethoxysilylpropyl) polysulfide containing an average in a range of from about 2 to about 2.6 connecting sulfur atoms in its polysulfidic bridge as Si266 ™ from Evonik
¹⁰Fatty acids comprised of stearic, palmitic and oleic acids
¹¹Sulfur cure accelerators as sulfenamide primary accelerator and diphenylguanidine secondary accelerator

The rubber Samples were prepared by blending the ingredients, other than the sulfur curatives, in a first non-productive mixing stage (NP1) in an internal rubber mixer for about 4 minutes to a temperature of about 160° C. The resulting mixtures were subsequently individually mixed in a second sequential non-productive mixing stage (NP2) in an internal rubber mixer to a temperature of about 140° C. The rubber compositions were subsequently mixed in a productive mixing stage (P) in an internal rubber mixer with the sulfur curatives comprised of the sulfur and sulfur cure accelerators for about 2 minutes to a temperature of about 115° C. The rubber compositions were each removed from the internal mixer after each mixing step and cooled to below 40° C. between each individual non-productive mixing stage and before the final productive mixing stage.

The following Table 2 illustrates various physical properties of rubber compositions based upon the basic formulation of Table 1 and reported herein as Control rubber Sample A and Experimental rubber Samples B through E. Where cured rubber samples are reported, such as for the stress-strain, hot rebound and hardness values, the rubber samples were cured for about 10 minutes at a temperature of about 170° C.

For the predictive wet traction, a tangent delta (tan delta) test was run at −10° C.

For the predictive low temperature (winter snow) performance, the rubber's stiffness test (storage modulus G′) was run at −20° C. to provide a stiffness value of the compounds (rubber compositions) at lower operating temperatures.

TABLE 2

| | Parts by Weight (phr) | | | | |
|---|---|---|---|---|---|
| Materials | Cntrl A | Exp B | Exp C | Exp D | Exp E |
| Traction resin A | 36 | 36 | 36 | 0 | 0 |
| Traction resin B | 0 | 0 | 0 | 37 | 0 |
| Traction resin C | 0 | 0 | 0 | 0 | 47 |
| Precipitated silica X | 140 | 0 | 0 | 0 | 0 |
| Precipitated silica Y | 0 | 140 | 160 | 160 | 160 |
| Properties | | | | | |
| Cold Weather (Winter) | | | | | |
| Performance (Stiffness) | | | | | |
| Laboratory Prediction | | | | | |
| Storage modulus (G′), | 17 | 11 | 15 | 14 | 16 |
| (MPa) at −20° C., | | | | | |
| 7.8 Hertz, 1.5% strain | | | | | |
| (lower stiffness | | | | | |
| values are better) | | | | | |
| Wet Traction | | | | | |
| Laboratory Prediction | | | | | |
| Tan delta, (−10° C.) | 0.54 | 0.48 | 0.53 | 0.55 | 0.63 |
| (higher values are better) | | | | | |
| Additional properties | | | | | |
| Tensile strength (MPa) | 15 | 12 | 11 | 12 | 12 |
| Elongation at break (%) | 529 | 462 | 479 | 475 | 508 |
| Modulus (ring) 300% | 7.6 | 7.8 | 7.3 | 8 | 7.1 |
| (MPa) | | | | | |
| Shore A hardness | 61 | 60 | 60 | 60 | 60 |
| (100° C.) | | | | | |
| Storage modulus G′, | 2.8 | 2.2 | 2.7 | 2.3 | 2.1 |
| (MPa) at 100° C., | | | | | |
| and 1% strain | | | | | |
| Rolling Resistance | | | | | |
| Predictive Property | | | | | |
| Tan delta, 50° C. | 0.27 | 0.19 | 0.22 | 0.27 | 0.26 |
| (lower is better) | | | | | |

### Observations from Table 2

### Wet Traction—Tan Delta (−10° C.) and Cold Weather Performance—G′ (−20° C.) Considerations

(A) Use of Precipitated Silica of Lower Surface Area

Experimental rubber Samples B and C used the same levels of the same traction resin (styrene-alphamethylstyrene copolymer) as Control rubber Sample A, although a precipitated silica having a substantially lower surface area was used (BET nitrogen surface area of 90 instead of a BET surface area of 125 m²/g for the precipitated silica of Control rubber Sample A).

Rolling resistance prediction property for a tire with tread of the respective rubber compositions (evidenced by the tan delta at 50° C.) was beneficially improved or maintained in a sense that the tan delta values were beneficially reduced for Experiment rubber Samples B and C and maintained for Experimental rubber Samples D and E.

Simultaneously, winter (low temperature) properties for Experimental rubber Samples B and C were improved (while also improving the aforesaid predictive rolling resistance) as evidenced by desirably reduced storage moduli G′ at −20° C.

However, wet traction predictive properties for Experimental rubber Samples B and C were reduced in a sense that the tan delta at −10° C. values were undesirably reduced as compared to Control rubber Sample A.

(B) Use of Traction Resins with Higher Softening Points

Experimental rubber Samples D and E used the same lower surface area precipitated silica as Experimental rubber Samples B and C (BET nitrogen surface area of 90 instead of a BET surface area of 125 m²/g for the precipitated silica of Control rubber Sample A).

However, Experimental rubber Samples D and E both used significantly higher softening point traction resins (120° C. and 145° C., respectively) than the traction resin used for rubber Sample A and for Experimental rubber Samples B and C having a substantially lower softening point of 85° C.

In particular, Experimental rubber Sample D used a styrene-alphamethylstyrene copolymer having a softening point of 120° C. and Experimental rubber Sample E used a terpene/phenol copolymer having a softening point of 145° C.

It is concluded that Experimental rubber Samples D and E, with a combination of high levels of low surface area precipitated silica together with high softening point traction promoting resins, provided better wet traction properties as compared to Control rubber Sample A. Simultaneously, an unpredicted and therefore discovered, predictive improvement in winter (low temperature) properties of Experimental rubber Samples D and E are obtained over the Control rubber sample A.

It is further concluded that the rolling resistance predictive property of Experimental rubber Samples D and E are beneficially maintained compared to the Control rubber Sample A.

While certain representative embodiments and details have been shown for the purpose of illustrating the invention, it will be apparent to those skilled in this art that various changes and modifications may be made therein without departing from the spirit or scope of the invention.

1. A pneumatic tire having a circumferential rubber tread intended to be ground-contacting, where said tread is a rubber composition comprised of, based on parts by weight per 100 parts by weight elastomer (phr):
(A) 100 phr of conjugated diene-based elastomers comprised of;
(1) about 50 to about 10 phr of cis 1,4-polybutadiene rubber having a Tg in a range of from about −90° C. to about −110° C. and an isomeric cis 1,4-content of at least 95 percent,
(2) about 50 to about 90 phr of styrene/butadiene elastomer having a Tg in a range of from about −65° C. to about −55° C.;
(B) about 100 to about 200 phr of rubber reinforcing filler comprised of rubber reinforcing carbon black and precipitated silica where said precipitated silica has a nitrogen surface area of in a range of from about 50 to about 110 m²/g, wherein the rubber reinforcing carbon black is present in an amount of from about 2 to about 15 parts by weight per 100 parts by weight rubber, together with silica coupling agent for the precipitated silica having a moiety reactive with hydroxyl groups on said precipitated silica and another different moiety interactive with said diene-based elastomers; and
(C) about 30 to about 70 phr of traction promoting resin comprised of at least one of styrene-alphamethylstyrene copolymer resin having a softening point in a range of from about 110° C. to about 130° C., terpene-phenol resin having a softening point in a range of from about 120° C. to about 170° C., coumarone-indene resins having a softening point in a range of from about 140° C. to about 150° C., petroleum hydrocarbon resins having a softening point in a range of from about 110° C. to about 170° C., and terpene polymer resins having a softening point in a range of from about 110° C. to about 170° C.;
wherein said styrene/butadiene elastomer has a styrene content in a range of from about 10 to about 20 percent and a vinyl 1,2-content based on its polybutadiene portion in a range of from about 25 to about 35 percent,
wherein said styrene/butadiene elastomer is an end-functionalized styrene/butadiene elastomer with functional groups reactive with hydroxyl groups on said precipitated silica comprised of alkoxy and at least one of primary amine and thiol groups, and
wherein said silica coupling agent is comprised of bis(3-triethoxysilylpropyl) polysulfide containing an average in range of from about 2 to about 4 sulfur atoms in its polysulfide bridge.

2. The tire of claim 1 wherein said traction promoting resin is comprised of at least one of said styrene-alphamethylstyrene resin and terpene-phenol resin.

3. (canceled)

4. (canceled)

5. (canceled)

6. (canceled)

7. The tire of claim 1 wherein said styrene/butadiene elastomer is an end-functionalized styrene/butadiene elastomer with functional groups comprised of alkoxy and thiol groups.

8. The tire of claim 1 wherein said precipitated silica and silica coupling agent are pre-reacted to form a composite thereof prior to their addition to the rubber composition.

9. The tire of claim 1 wherein said precipitated silica and silica coupling agent are added to the rubber composition and reacted together in situ within the rubber composition.

10. (canceled)

11. (canceled)

12. The tire of claim 1 wherein said silica coupling agent is comprised of a bis(3-triethoxysilylpropyl) polysulfide containing an average of from about 2 to about 2.6 sulfur atoms in its polysulfidic bridge.

13. (canceled)

14. (canceled)

15. The tire of claim 1 wherein said traction promoting resin is said petroleum hydrocarbon resin.

16. The tire of claim 1 wherein said traction promoting resin is said terpene polymer resin.

17. (canceled)

18. (canceled)

19. The tire of claim 1 wherein said tread rubber composition is sulfur cured.

20. The tire of claim 8 wherein said tread rubber composition is sulfur cured.

20. The tire of claim 9 wherein said tread rubber composition is sulfur cured.

21. The tire of claim 1 wherein said traction promoting resin is comprised of said styrene-alphamethylstyrene resin.

22. The tire of claim 21 wherein said styrene-alphamethylstyrene resin has a styrene content in a range of from about 10 to about 90 percent.

23. The tire of claim 1 wherein said traction promoting resin is comprised of said terpene-phenol resin where said terpene-phenol resin is comprised of a copolymer of phenolic monomer with a terpene comprised of at least one of limonene and pinene.
